(19) United States
(12) Patent Application Publication
(10) Pub. No.: US 2025/0200223 A1
(43) Pub. Date: Jun. 19, 2025

(54) SYSTEMS AND METHODS FOR SELECTIVE DEIDENTIFICATION OF MESSAGES INCLUDING PATIENT INFORMATION

(71) Applicant: Healthcare TTU, Inc., Littleton, CO (US)

(72) Inventors: Travis W. Gentry, Highlands Ranch, CO (US); Timothy R. Estes, Castle Rock, CO (US); Michael J. Cunningham, Littleton, CO (US); Jae R. Waldron, Murfreesboro, TN (US); Dale Ray Alexander, Montgomery, AL (US)

(21) Appl. No.: 19/065,773

(22) Filed: Feb. 27, 2025

Related U.S. Application Data
(63) Continuation of application No. 17/698,431, filed on Mar. 18, 2022.
(60) Provisional application No. 63/164,293, filed on Mar. 22, 2021.

(51) Int. Cl. G06F 21/62; G06F 21/60

(52) U.S. Cl. CPC G06F 21/6254; G06F 21/602; G06F 2221/2107

(57) ABSTRACT

A method as disclosed herein includes securely linking a client computing system to a host computing system via a communications network comprising first and second interface modules, wherein the first interface module resides on the client computing system and the second interface module resides on the host computing system. Upon receiving an original message originating from the client computing system at either of the first interface module or the second interface module, the method further includes obfuscating one or more patient data elements associated with the original message while maintaining a file structure from the original message, and transmitting a deidentified message otherwise corresponding to the original message to a data storage module associated with the host computing system. An appropriate destination is determined for the deidentified message and at least a copy of the deidentified message is routed to the determined destination.

### CROSS-REFERENCES TO RELATED APPLICATIONS

This application is a continuation of U.S. patent application Ser. No. 17/698,431, filed Mar. 18, 2022, entitled “Systems and Methods for Selective Deidentification of Messages Including Patient Information,” which claims benefit of U.S. Provisional Patent Application No. 63/164,293, filed Mar. 22, 2021, each of which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present disclosure relates generally to systems and methods for de-identifying information and providing services. In today's world, Personally Identifiable Information (PII) and Protected Health Information (PHI) are extremely sensitive data elements which are often the subject of data breaches and lawsuits. Healthcare providers (such as hospitals, clinics, physicians, etc.) go to great lengths to protect this information. Healthcare providers (e.g., Covered Entities) regularly need to transmit this information outside of their control to vendors (e.g., Business Associates). Health Insurance Portability and Accountability Act (HIPAA) standards have been developed to provide safeguards around this data and detail how it must be protected. Covered Entities and Business Associates must sign Business Associate Agreements (BAA) defining the terms and use of the data. These obligations and expenses relating to PII and PHI impose a substantial burden.

### BRIEF SUMMARY

Inventions consistent with the present disclosure address the problems identified above, amongst others. Implementations consistent with the present disclosure may provide systems, apparatuses, and methods for providing de-identification of healthcare data. For example, a file with PII/PHI may be provided and PII/PHI data elements contained therein or associated therewith may be scrambled, selectively removed, and/or encrypted. The file structure may be maintained through the process while the PII/PHI is removed in various embodiments. In contrast to the solutions provided according to aspects of the present disclosure, there is no commercially available software or appliance available to providers capable of scrubbing PHI from data files. The industry needs this solution that renders PHI data inert in the manner disclosed herein.

In a related field, claims data such as an 837 claim and/or 835 remittance data file is a common data transmission in the industry, but the 837/835 data file is replete with PHI. The non-PHI data contained in claims data may be valuable. In many instances, it is not necessary to know or involve the PHI contained in the data set, but providers do not have the means to transmit deidentified data, therefore the only option is to transmit PHI. As such, those receiving the provider data are forced to build extremely expensive and secure infrastructure to receive, store, and use PHI. Those receiving the data from the provider may further be required to buy higher levels of cyber insurance because of the PHI received. If PII/PHI data was de-identified according to aspects of the present disclosure, the cyber risk, required insurance, and infrastructure cost may be greatly reduced.

In a particular embodiment, a method as disclosed herein includes securely linking a client computing system to a host computing system via a communications network comprising first and second interface modules, wherein the first interface module resides on the client computing system and the second interface module resides on the host computing system. Upon receiving an original message originating from the client computing system at either of the first interface module or the second interface module, the method further includes obfuscating one or more patient data elements associated with the original message while maintaining a file structure from the original message, and transmitting a deidentified message otherwise corresponding to the original message to a data storage module associated with the host computing system. An appropriate destination is determined for the deidentified message and at least a copy of the deidentified message is routed to the determined destination.

In an exemplary and optional further aspect according to the above-referenced embodiment, the step of obfuscating one or more patient data elements associated with the original message while maintaining the file structure for the message may be performed at least in part by determining the one or more patient data elements to be obfuscated and further generating one-way hashes to be inserted into the original file structure in place of the determined one or more patient data elements.

In various exemplary and optional further aspects according to the above-referenced embodiment, the one or more patient data elements to be obfuscated may be determined according to respectively populated data fields in the message, according to a rules-based analysis of message data, and/or according to the file structure of the original message.

In another exemplary and optional further aspect according to the above-referenced embodiment, the step of obfuscating one or more patient data elements associated with the original message while maintaining the file structure for the original message may be performed at least in part by selecting an obfuscation model for the message based on its original file structure, and wherein the one or more patient data elements are selected for obfuscation and subsequently obfuscated via application of the selected obfuscation model.

In another exemplary and optional further aspect according to the above-referenced embodiment, messages originating from the client computing system may be received by the host computing system via one of the first interface module or the second interface module depending on a type of the original message.

In another exemplary and optional further aspect according to the above-referenced embodiment, the type of the original message may correspond to the file structure of the original message.

In another exemplary and optional further aspect according to the above-referenced embodiment, the first interface module or the second interface module may deliver deidentified messages to a receiving module on the host computing system, the method further comprising determining at the receiving module whether the message has been adequately deidentified before transmittal to the data storage module.

In another exemplary and optional further aspect according to the above-referenced embodiment, the method may further comprise preventing transmittal of the deidentified message to the data storage module if the message is determined to have been inadequately deidentified and generating a notification thereof to the client computing system.

In another embodiment as disclosed herein, a host computing system is securely linked to a client computing system via a communications network comprising first and second interface modules. The first interface module resides on the client computing system and the second interface module resides on the host computing system. The host computing system comprises one or more non-transitory computer readable media having program instructions residing thereon and executable by data processors further associated with the host computing system to direct the performance of steps according to the above-referenced method and any exemplary and optional aspects thereof.

Numerous other objects, features, and advantages of the present invention will be readily apparent to those skilled in the art upon a reading of the following disclosure when taken in conjunction with the accompanying drawings.

### BRIEF DESCRIPTION OF THE SEVERAL VIEWS OF THE DRAWINGS

FIG. 1 provides an exemplary embodiment of a network for providing a system according to aspects of the present disclosure.

FIG. 2 illustrates an exemplary embodiment of a functional diagram of data services, state, and flow according to aspects of the present disclosure.

FIG. 3 illustrates an exemplary embodiment of a method according to aspects of the present disclosure.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

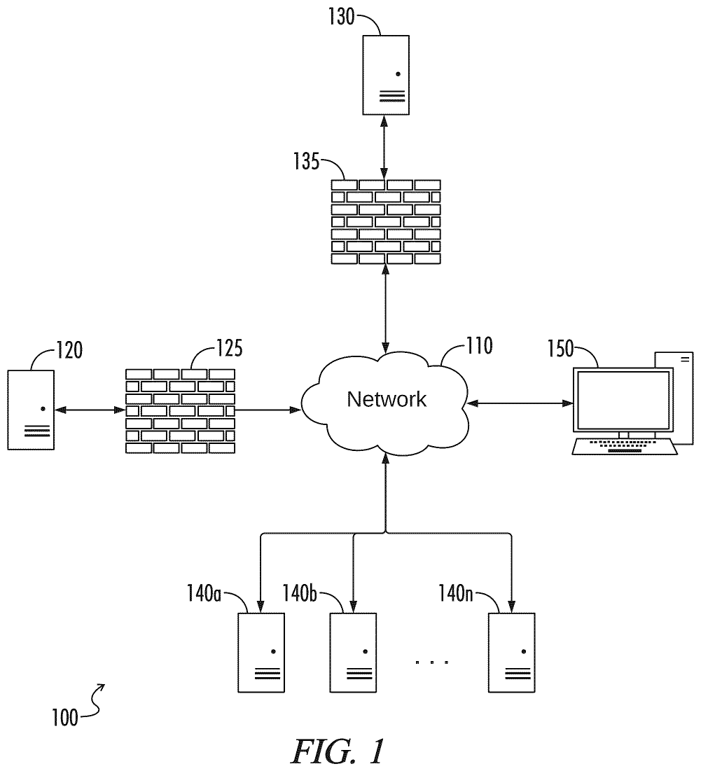

Referring generally to FIGS. 1-3, various exemplary apparatuses and associated methods according to the present disclosure are now described in detail. Where the various figures may describe embodiments sharing various common elements and features with other embodiments, similar elements and features are given the same reference numerals and redundant description thereof may be omitted below.

As shown in FIG. 1, provided is an exemplary embodiment of a network for providing a system according to aspects of the present disclosure. The system 100 includes a network 110 capable of being coupled to one or more other computing elements. In one exemplary embodiment, the network 110 includes the Internet, a public network, a private network, or any other communications medium capable of conveying electronic communications. The system 100 may further include a client (e.g., health system) computing device 120, a host computing device 130, one or more cloud computing elements 140, and/or a user device 150.

Communication between a communication module (not illustrated) of the client computing device 120 and the network 110 is configured to be performed by wired interface, wireless interface, or a combination thereof, without departing from the spirit and the scope of the present disclosure. At least one firewall 125 may be interposed between the network 110 and client computing device 120. In one exemplary operation, the client computing device 120 is configured to store one or more sets of instructions in a storage coupled thereto or otherwise capable of being communicatively coupled to the client computing device 120. The one or more sets of instructions may be configured to be executed by a hardware and/or software processor of the client computing device 120 to perform one or more operations corresponding to the one or more sets of instructions.

In various exemplary embodiments, the client computing device 120 may be implemented as at least one of a server computer, a server device, a desktop computer, a laptop computer, a smart phone, or any other electronic device capable of executing instructions. The microprocessor of the client computing device 120 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The client computing device 120 is configured in various embodiments to operate remotely and may be configured to obtain or otherwise operate upon one or more instructions stored physically remote from the client computing device 120 (e.g., via client-server communications and/or cloud-based computing).

The system 100 may further include the host computing device 130 coupleable to the network 110. Communication between a communication module (not illustrated) of the host computing device 130 and the network 110 is configured to be performed by wired interface, wireless interface, or a combination thereof, without departing from the spirit and the scope of the present disclosure. At least one firewall 135 may be interposed between the network 110 and the host computing device 130. In one exemplary operation, the host computing device 130 is configured to store one or more sets of instructions in a storage coupled thereto or otherwise capable of being communicatively coupled to the host computing device 130. The one or more sets of instructions may be configured to be executed by a hardware and/or software processor of the host computing device 130 to perform one or more operations corresponding to the one or more sets of instructions.

In various exemplary embodiments, the host computing device 130 may be implemented as at least one of a server computer, a server device, a desktop computer, a laptop computer, a smart phone, or any other electronic device capable of executing instructions. The microprocessor of the host computing device 130 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The host computing device 130 is configured in various embodiments to operate remotely and may be configured to obtain or otherwise operate upon one or more instructions stored physically remote from the host computing device 130 is configured in various embodiments to operate remotely and may be configured to obtain or otherwise operate upon one or more instructions stored physically remote from the host computing device 130 (e.g., (e.g., is configured in various embodiments to operate remotely and may be configured to obtain or otherwise operate upon one or more instructions stored physically remote from the host computing device 130 (e.g., via client-server communications and/or cloud-based computing).

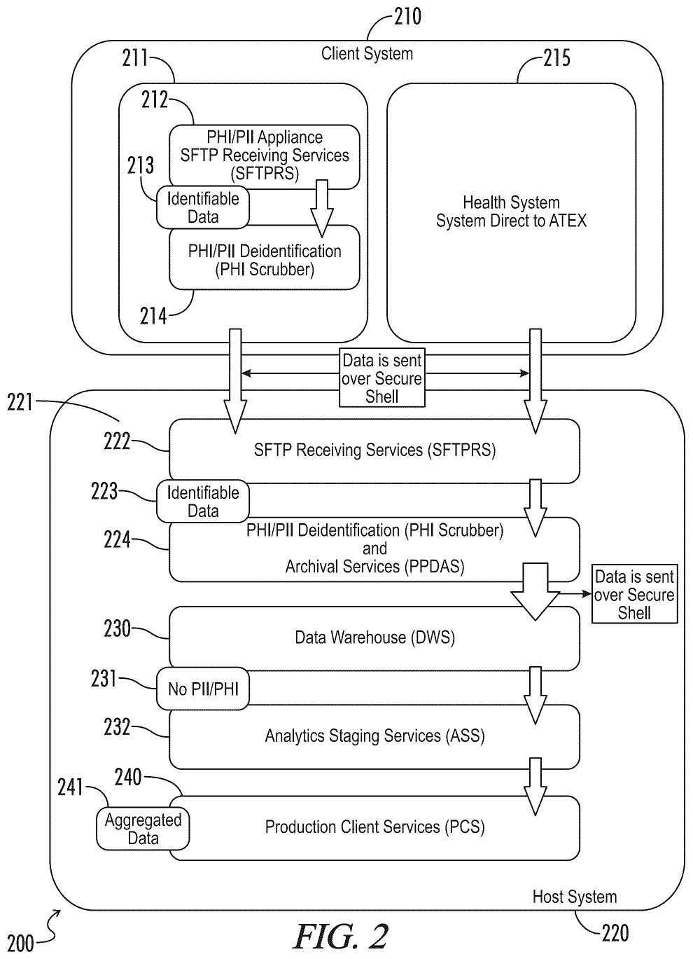

At least one cloud computing element 140a, 140b, . . . , 140n may be coupled or otherwise configured for coupling to the network 110. One or more cloud computing element 140 may be configured to store one or more sets of data or information usable according to aspects of the present disclosure, for example as described herein with reference to FIG. 2. Communication between a communication module (not illustrated) of the one or more cloud computing element 140 and the network 110 is configured to be performed by wired interface, wireless interface, or a combination thereof, without departing from the spirit and the scope of the present disclosure. In one exemplary operation, the one or more cloud computing element 140 is configured to store one or more sets of instructions in a storage coupled thereto or otherwise capable of being communicatively coupled to the one or more cloud computing element 140. The one or more sets of instructions may be configured to be executed by a hardware and/or software processor of the one or more cloud computing element 140 to perform one or more operations corresponding to the one or more sets of instructions.

In various exemplary embodiments, the one or more cloud computing element 140 may be implemented as at least one of a server computer, a server device, a desktop computer, a laptop computer, a smart phone, or any other electronic device capable of executing instructions. The microprocessor of the one or more cloud computing element 140 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The one or more cloud computing element 140 is configured in various embodiments to operate remotely and may be configured to obtain or otherwise operate upon one or more instructions stored physically remote from the one or more cloud computing element 140 is configured in various embodiments to operate remotely and may be configured to obtain or otherwise operate upon one or more instructions stored physically remote from the one or more cloud computing element 140 (e.g., is configured in various embodiments to operate remotely and may be configured to obtain or otherwise operate upon one or more instructions stored physically remote from the one or more cloud computing element 140 (for example, via client-server communications and/or cloud-based computing)).

At least one user device 150 may be coupled or otherwise configured for coupling to the network 110. One or more user device 150 may be configured to store one or more sets of data or information usable according to aspects of the present disclosure, for example as described herein with reference to FIG. 2. Communication between a communication module (not illustrated) of the at least one user device 150 and the network 110 is configured to be performed by wired interface, wireless interface, or a combination thereof, without departing from the spirit and the scope of the present disclosure. In one exemplary operation, the at least one user device 150 is configured to store one or more sets of instructions in a storage coupled thereto or otherwise capable of being communicatively coupled to the at least one user device 150. The one or more sets of instructions may be configured to be executed by a hardware and/or software processor of the at least one user device 150 to perform one or more operations corresponding to the one or more sets of instructions.

In various exemplary embodiments, the at least one user device 150 may be implemented as at least one of a server computer, a server device, a desktop computer, a laptop computer, a smart phone, or any other electronic device capable of executing instructions. The microprocessor of the at least one user device 150 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The at least one user device 150 is configured in various embodiments to operate remotely and may be configured to obtain or otherwise operate upon one or more instructions stored physically remote from the at least one user device 150 is configured in various embodiments to operate remotely and may be configured to obtain or otherwise operate upon one or more instructions stored physically remote from the at least one user device 150 (e.g., is configured in various embodiments to operate remotely and may be configured to obtain or otherwise operate upon one or more instructions stored physically remote from the at least one user device 150 (for example, via client-server communications and/or cloud-based computing)).

FIG. 2 illustrates an exemplary embodiment of a functional diagram of data services, state, and flow according to aspects of the present disclosure. The system 200 includes one or more of a client system (e.g., health care enclave) 210 and/or a host system (e.g., host enclave) 220 which may be configured to communicate with one another (e.g., via the network 110 of FIG. 1). In various exemplary embodiments, communication between the client system 210 and the host system 220 may be performed using a secure shell connection. The client system 210 may be implemented by or in conjunction with, in whole or in part, at least one client computing device 120 in various embodiments. The client system 210 may include a health system direct communication module which is configured to communicate at least a portion of information directly from the client system 210 to the host system 220 (e.g., via the network 110 of FIG. 1). Communications between the client system 210 and the host system 220 may occur using at least one communication module (not illustrated) associated with one or more client system 210 and/or host system 220. The host system 220 may be implemented by or in conjunction with, in whole or in part, at least one host computing device 130 in various embodiments.

The client system enclave 210 may be located at a health system location or at a location associated with a health system in various exemplary embodiments. The client system enclave may include a host interface 211 further including a PII/PHI appliance module 212. The PII/PHI appliance module 212 may include a Secure File Transfer Protocol (SFTP) Receiving Services (SFTPRS) module 212. The SFTPRS module 212 may be configured to transfer information 213 including identifiable information and/or non-identifiable information to a PII/PHI Deidentification (PHI Scrubber) module 214. The PHI Scrubber module 214 may be configured to perform at least one operation on at least a portion of the information provided from the SFTPRS module 212. The at least one operation may include, for example, a de-identification operation. The de-identification operation may include one or more of a removal operation on at least a portion of identifiable information (such as PII/PHI), an obfuscation operation on at least a portion of identifiable information, an encoding operation on at least a portion of identifiable operation, a complete removal operation, an information adding operation, an editing operation, and/or any other operation configured to operate upon information, metadata associated with the information, or a representation corresponding to the information.

In an embodiment, whether communicated from the client system enclave 210 directly (via 215) to the host system enclave 220 or communicated from the PII/PHI appliance 212, the host systems enclave 220 may be configured to receive the information at a host-based interface 221 including an SFTP Receiving Services (SFTPRS) module 222 of the host systems enclave 220. The SFTPRS module 222 may be configured to transfer information 223 including identifiable information and/or non-identifiable information to a host PII/PHI Deidentification and Archival Services (PPDAS) module 224. The PPDAS module 224 may be configured to perform at least one operation on at least a portion of the information provided from the SFTPRS module 222. The at least one operation may include, for example, a de-identification operation. The de-identification operation may include one or more of a removal operation on at least a portion of identifiable information (such as PII/PHI), an obfuscation operation on at least a portion of identifiable information, an encoding operation on at least a portion of identifiable operation, a removal operation, an information adding operation, an editing operation, and/or any other operation configured to operate upon information, metadata associated with the information, or a representation corresponding to the information. The at least one operation may additionally or alternatively include an archival operation. The archival operation may include storing at least a portion of information received at the PPDAS. The information may be stored at a storage unit (not illustrated) of the host systems enclave 220, at a remote location, or a combination thereof. In various embodiments, the at least one operation may include not performing an operation on the information (for example, when no operation is to be performed at all, when at least one operation is to be performed in association with the information but not upon the information itself, etc.).

After passing through the PHI Scrubber and PPDAS module 224, information may be transmitted to a host Data Warehouse Services (DWS) module 230, for example via a secure shell connection. The DWS module 230 may be configured to perform at least one data warehousing operation on or in association with the information. The at least one operation may include storing at least a portion of the information or representation thereof. It should be noted that the information received at the DWS module 230 from the PHI Scrubber and PPDAS module 224 may no longer contain PII/PHI, thus archival at the host systems enclave 220 and/or storage associated with the host systems enclave 220 may be capable of use.

The DWS module 230 may be configured to convey information 231 that does not contain PII/PHI to a host Analytics Staging Services (ASS) module 232. The ASS module 232 may be configured to perform at least one staging operation upon at least a portion of information received from the DWS module 230.

The ASS module 232 may be configured to transfer at least a portion of information to a host Production Client Services (PCS) module 240. The PCS module 240 may be configured to provide at least one production operation, for example using aggregated data, the aggregated data having been at least partially received from the ASS module 232 and may be configured to transmit one or more sets of information associated with the at least one production operation, for example to a user (e.g., via user device 150), optionally based at least in part upon a request for information received from or otherwise in association with the user.

One or more modules, elements, or subset(s) thereof illustrated by or otherwise included within the elements depicted by FIG. 2 may be implemented using at least one Virtual Private Cloud (VPC). At least one VPC may be provided by a third-party vendor without departing from the spirit and scope of the present disclosure. At least one VPC may be implemented, for example, in whole or in part by at least one cloud computing element 140a, 140b, . . . , 140n.

The PII/PHI Appliance module 211 may be located, in whole or in part, at the client system enclave 210. The Appliance module 211 may be configured to permit access only to health system engineers and/or only authorized individuals in various embodiments. Inbound network traffic may be limited to the client system rather than to the host PII/PHI Appliance module 211 in various embodiments. Outbound traffic may be optionally limited to the host enclave SFT Receiving Services module 221 via the host PII/PHI Appliance module 211. Data and information handled by the PII/PHI Appliance module 211 may include PII and/or PHI.

The first interface 211 including the PII/PHI Appliance module 212 may be deployed within the client system enclave 210 as an appliance and may be configured to receive one or more Health Level Seven (HL7) messages, to perform at least one de-identification operation, and/or to forward at least a portion of the de-identified data to the SFTPRS module (e.g., at a physical and/or virtual host location or element). The Appliance module 212 may provide secure FTP access using one or more Transport Layer Security (TLS) protocols for customers delivering electronic health transaction files in the format of HL7 X12, CSV, XML, or the like. The SFTPRS module may use a commercially available Linux system with an OpenSSH engine to facilitate secure transfer of data. Users associated with a client (e.g., customers of the host) may be provided with one or more sets of credentials, for example either as a combination of username and password or an SSL certificate. To ensure no customer data spillage occurs, customer accounts may be limited to only having the ability to write data, and data may be siloed so data associated with only one customer resides in a respective physical location.

PHI Scrubber module 214 may provide the ability to de-identify one or more sets of incoming health data by obfuscating PII/PHI contained within electronic health documents provided by customers. To accomplish the obfuscating, the system may use computer software using one or more industry-standard cryptography cyphers to create one-way hash values to replace the original value(s) within the electronic file(s) provided. These values by design cannot be reversed to determine the original value. Examples of data that may be obfuscated include patient names, patient identifiers, patient demographics, and any other form of PII/PHI. An exemplary, partial, and non-exhaustive list of items which may be identified as possibly containing PII/PHI data and which may be obfuscated in various embodiments by the PHI Scrubber is represented below in Table 1.

| | X12 | Elements | |
|---|---|---|---|
| X12 Segment | Document | Scrubbed | Method |
| REF with | 837/835 | REF-02 | One-way Hash |
| Qualifiers: | | | |
| 1W, 28, EA, SY, | | | |
| 0B, 1A, 1B, 1C, | | | |
| 1D, 1G, 1H, G2, | | | |
| EI, Y4 | | | |
| NM1 Segment with | 837/835 | NM1-03, NM1-04, | One-way Hash |
| Qualifiers: QC, 1L | | NM1-05, NM1-06, | |
| | | NM1-07, NM1-09 | |
| CLM | 837 | CLM-01 | One-way Hash |
| CLP | 835 | CLP-01 | One-way Hash |
| N3 | 837 | N3-01, N3-02 | One-way Hash |
| DMG | 837 | DMG-02 | Date Stripped |
| | | | of Month and |
| | | | Day |
| BPR | 837/835 | BPR-07, BPR-09, | Replace with |
| | | BPR-13, BPR-15 | static value |
| | | | based on |
| | | | location for |
| | | | example |
| | | | BPR-07 may be |
| | | | replaced with |
| | | | all 0's and |
| | | | BPR-9 with all |
| | | | 1's. |
| NTE | 837 | NTE-02 | One-way Hash |

The SFTPRS module at the client system enclave 210 may provide limited access to one or more human users, such as being limited to customers and host-identified engineers, among other optionally accessible users. Network access may be in-bound only in various embodiments. Internet access may be limited to whitelisted domains and/or addresses. Network access management may be provided for example, via a management portal or system via a Virtual Private Network (VPN).

The interface 221 including SFTPRS module 222 at the host systems enclave 220 may be one of two customer-facing interfaces with respect to (e.g., entry points into) the host product suite. The SFTPRS module 222 may provide secure FTP access using one or more TLS protocols for customers delivering electronic health transaction files, for example in the format of HL7 X12, CSV, XML, or the like. The SFTPRS module 222 may be provided using a commercially available software with a firewall in front and behind to restrict virtual, physical access, and network traffic to and from the services. Customers may be provided with one or more sets of credentials, for example either a combination of username and password or SSL certificate. To ensure no customer data spillage occurs, customer accounts may only be provided with the ability to write data in various embodiments, and data may be siloed such that data for only one customer resides at a respective physical location. Data and information handled by the SFTPRS module 222 may include PII/PHI in various embodiments.

The PHI Scrubber and Archival Services (PPDAS) module 224 may be configured as to provide limited user access, for example as limited to only host-identified engineers and/or other authorized users. The PHI Scrubber and PPDAS module 224 may be configured such that no general internet access is provided to the PHI Scrubber and PPDAS module 224 in various embodiments. The PHI Scrubber and PPDAS module 224 may be selectively configured to be managed, for example via a VPN connection interface. Data and information handled by the PHI Scrubber and PPDAS module 224 may include PII/PHI in various embodiments.

The PHI Scrubber and PPDAS module 224 may be configured to provide the ability to de-identify at least a portion of incoming health data, for example by obfuscating at least a portion of received PII/PHI and may be configured to provide archival of electronic health documents provided by customers. The PHI Scrubber and PPDAS module 224 may be configured with a firewall in front of and/or and behind to restrict virtual access, physical access, and network traffic to and from the service(s) provided thereby. The PHI Scrubber and PPDAS module 224 services may be configured to not be accessible via the internet and may be only accessible by identified host personnel or other users authorized and/or trained in the handling of PII/PHI data in various embodiments.

To provide at least one obfuscating function, one or more systems may include computer software using industry standard cryptography cyphers to create one-way hash values to replace one or more original values within at least one provided electronic file. These values by design cannot be reversed to determine the original value. Examples of data that may be obfuscated include, but are not limited to, patient names, patient identifiers, patient demographics, and/or any form or content of identifiable information.

One or more PHI Scrubber and PPDAS module 224 services may be configured to assume that all data will include PII/PHI and may be configured in various embodiments to review the data to ensure that it has been de-identified, even if the data originated from the PII/PHI Appliance 212.

Customer health data may be archived with original PII/PHI in an encrypted format utilizing industry standards for cryptography in various embodiments.

The DWS module 230 may be configured to limit access to only authorized users, such as only to host-identified engineers or other authorized users. The DWS module 230 may be provided with no internet access in various embodiments and may be configured to be managed using a management interface accessible via VPN. The data and information handled by the DWS module 230 may be configured to be without any PII/PHI based at least in part upon one or more PII/PHI scrubbing operations performed on the data or information and/or representation of such in advance of receipt of the data or information or representation of such at the DWS module 230. In various exemplary embodiments, the DWS module 230 may be and/or incorporate at least one big data implementation and/or one or more relational database systems configured to selectively allow access to at least one health document.

The ASS module 232 may be configured to limit access to authorized users, for example by limiting access to host-identified engineers and/or other authorized users. The ASS module 232 may be configured without internet access in various embodiments and may be managed via an interface accessible via VPN in various embodiments.

The ASS module 232 may be a combination of a relational database and one or more software systems used to analyze and provide one or more consumable statistical results for the one or more product suite described herein.

One or more embodiment may be configured to take advantage of a Relational Database Service (RDS) configured to provide a scalable relational database in a virtual private cloud which can optionally be resized to increase capacity, as necessary. In addition to the benefits offered by RDS, the foundation of the ASS engine 232 may be configured to incorporate the use of a messaging architecture to provide standardized communication across various embodiments, as well as to optionally manage process flow control and scale. The ASS engine 232 itself may include multiple components configured to leverage the messaging architecture to send/receive messages and/or to perform actions accordingly. This approach may assist in providing the ability to introduce new capabilities within the ASS module 232 processes with limited modifications and impact. The components may be configured to be run in unison while increasing system throughput without the need for additional infrastructure.

The PCS module 240 may be configured to provide limited access, for example to customers, host-identified engineers, and/or other authorized users. Network access for the PCS module 240 may be limited to only inbound internet and may be configured to be managed via a management interface accessible via VPN. Data and information handled by the PCS module 240 may be configured as not to include PII/PHI.

The PCS module 240 may be configured to provide one or more customer-facing systems for one or more provided services. The PCS module 240 may include an administrative control interface (e.g., a web-based interface) configured to permit control over one or more aspects of the system.

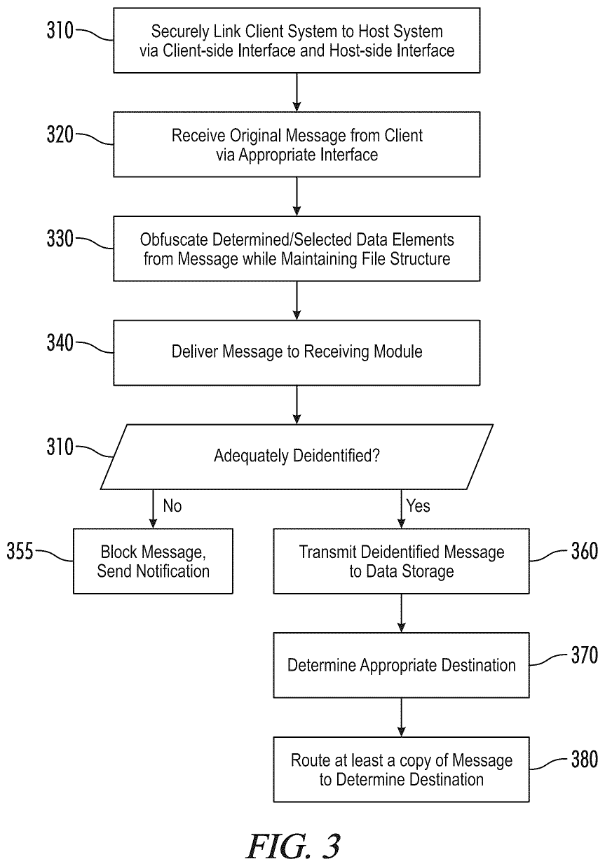

An exemplary embodiment of a method 300 as disclosed herein may now be described with further illustrative reference to FIG. 3. While the method 300 may be described with reference to elements of systems 100, 200 as noted above, the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps may be described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The steps or algorithms of the method 300 as described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

The method 300 may begin (step 310) with the secure linking of a client system enclave 210 and a host systems enclave 220 via at least a first (client-side) interface 211 and a second (host-side) interface 221. The interfaces 211, 221 may each for example be considered part of a host system even while at least one interface 211 resides as an appliance on a client enclave 210.

The method 300 may further include a step 320 of receiving an original message from the client system 210 via one of the interfaces 211, 221. In an embodiment, users associated with the client system enclave 210 may select any of one or more available customer-facing interfaces for generating and/or transmitting the original message, wherein for example the message may be delivered to the host systems enclave 220 directly (i.e., via 215) or via the first interface 211. Alternatively, in an embodiment an appropriate interface 211 or 221 for a particular message may be determined based on, for example, a type of the message. The type of the original message may be determined by distributed logic associated with the host system, and may for example be determined as corresponding to the file structure of the original message.

Upon receiving an original message originating from the client system 210 at either of the client-side interface 211 or the host-side interface 221, the method 300 may continue by obfuscating one or more patient data elements associated with the original message while maintaining a file structure from the original message (step 330). The obfuscation may be performed by for example determining the one or more patient data elements to be obfuscated and further generating one-way hashes to be inserted into the original file structure in place of the determined one or more patient data elements. In an embodiment, the one or more patient data elements to be obfuscated may be determined according to respectively populated data fields in the message, wherein for example the data fields have been predetermined. In addition, or in the alternative, the one or more patient data elements to be obfuscated may be determined according to a rules-based analysis of message data. In addition, or in the alternative, the one or more patient data elements to be obfuscated may be determined at least in part according to the file structure of the original message.

In an embodiment, the obfuscation may be performed at least in part by selecting an obfuscation model for the message based on its original file structure. One or more patient data elements may be selected for obfuscation and subsequently obfuscated via application of the selected obfuscation model.

Upon performance of the initial obfuscation step 330, the method 300 may continue with delivery of the message to a module of the host systems enclave 220 which is appropriately configured to determine whether the message has been adequately deidentified (step 350). If the message is determined to have not been adequately deidentified, the host systems enclave 220 may accordingly prevent further transmittal of the message. In an embodiment, a notification may further be generated to the client system enclave 210 or otherwise directly to a transmitting user device or other interface to indicate that the original message has not been delivered (step 355).

If the message is determined to have been adequately deidentified, or at least in the event that inadequate deidentification has not been determined, the method 300 may continue with transmittal of the deidentified message (for example having certain data elements obfuscated but otherwise corresponding to the original message) to a data storage module (e.g., DWS module 230) associated with the host systems enclave 220 (step 360).

Further in accordance with various embodiments of a method 300 as disclosed herein, the message, associated data elements, and/or metadata tagged thereto may be examined to determine an appropriate destination for the deidentified message (step 370), and at least a copy of the deidentified message may further be routed to the determined destination (step 380).

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims. The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method for de-identifying identifiable information of a patient, the method comprising:
securely linking a client computing system to a host computing system via a communications network comprising a first interface module and a second interface module, wherein the first interface module resides on the client computing system and the second interface module resides on the host computing system, each of the first interface module and the second interface module configured to obfuscate one or more data elements of the patient;
upon receiving an original message originating from the client computing system at either of the first interface module or the second interface module, obfuscating the one or more data elements of the patient based upon respectively populated data fields in the original message, the one or more data elements associated with the original message while maintaining a file structure from the original message;
determining, at a receiving module of the host computing system, whether the one or more data elements have been obfuscated such that the original message has been deidentified as a deidentified message whereby the patient is not identifiable by name, one or more demographics, or one or more identifiers;
if the original message is determined to have been deidentified, transmitting the deidentified message otherwise corresponding to the original message to a data storage module associated with the host computing system
if the original message is determined to have been deidentified, preventing transmittal of the original message to the data storage module and generating a notification to the client computing system; and
after the original message has been deidentified as the de-identified message, determining an appropriate destination for the deidentified message and routing at least a copy of the deidentified message to the determined destination.

22. The method of claim 21, wherein obfuscating the one or more data elements associated with the original message while maintaining the file structure from the original message is performed at least in part by determining the one or more data elements to be obfuscated and further generating one-way hashes to be inserted into an original file structure in place of the one or more patient elements.

23. The method of claim 21, wherein the respectively populated data fields in the original message are predetermined.

24. The method of claim 21, wherein the one or more data elements to be obfuscated are determined according to a rules-based analysis of the one or more data elements in the original message.

25. The method of claim 21, wherein the one or more data elements to be obfuscated are determined at least in part according to the file structure of the original message.

26. The method of claim 21, wherein obfuscating one or more data elements associated with the original message while maintaining the file structure for the original message is performed at least in part by selecting an obfuscation model for the original message based on an original file structure, and wherein the one or more data elements are selected for obfuscation and subsequently obfuscated via application of the selected obfuscation model.

27. The method of claim 21, wherein the original message originating from the client computing system is received by the host computing system via one of the first interface module or the second interface module depending on a type of the original message.

28. The method of claim 27, wherein the type of the original message corresponds to the file structure of the original message.

29. The method of claim 21, wherein the first interface module or the second interface module delivers deidentified messages to the receiving module on the host computing system.

30. The method of claim 21, further comprising archiving, in a data warehouse services (DWS) module, the one or more data elements associated with the original message in an encrypted format.

31. A system for de-identifying identifiable information of a patient, the system comprising:
a network;
a client computing system having a first interface module residing thereon, the client computing system communicatively coupled to the network;
a host computing system having a second interface module residing thereon, the host computing system communicatively coupled to the network and securely linked to the client computing system via the network, wherein the host computing system comprises one or more non-transitory computer readable media having program instructions residing thereon and executable by data processors further associated with the host computing system to:
upon receiving an original message originating from the client computing system at either of the first interface module or the second interface module, obfuscate one or more data elements of the patient based upon respectively populated data fields in the original message, the one or more data elements associated with the original message while maintaining a file structure from the original message;
determine, at a receiving module of the host computing system, whether the one or more data elements have been obfuscated such that the original message has been deidentified as a deidentified message whereby the patient is not identifiable by name, one or more demographics, or one or more identifiers;
if the original message is determined to have been deidentified, transmit the deidentified message otherwise corresponding to the original message to a data storage module associated with the host computing system; and
if the original message is determined to have not been deidentified, prevent transmittal of the deidentified message to the data storage module and generate a notification to the client computing system; and
after the original message has been deidentified, determine an appropriate destination for the deidentified message and route at least a copy of the deidentified message to the determined destination.

32. The system of claim 31, wherein the host computing system obfuscates the one or more data elements associated with the original message while maintaining the file structure for the original message by determining the one or more data elements to be obfuscated and further generating one-way hashes to be inserted into an original file structure in place of the determined one or more data elements.

33. The system of claim 31, wherein the respectively populated data fields in the original message are predetermined.

34. The system of claim 31, wherein the one or more data elements to be obfuscated are determined according to a rules-based analysis of the one or more data elements in the original message.

35. The system of claim 31, wherein the one or more data elements to be obfuscated are determined at least in part according to the file structure of the original message.

36. The system of claim 31, wherein the host computing system obfuscates the one or more data elements associated with the original message while maintaining the file structure for the original message by selecting an obfuscation model for the original message based on an original file structure, and wherein the one or more data elements are selected for obfuscation and subsequently obfuscated via application of the selected obfuscation model.

37. The system of claim 31, wherein the original message originating from the client computing system is received via one of the first interface module or the second interface module depending on a type of the original message.

38. The system of claim 37, wherein the type of the original message corresponds to the file structure of the original message.

39. The system of claim 31, wherein the first interface module or the second interface module delivers deidentified messages to the receiving module on the host computing system.

40. The system of claim 31, wherein the host computing system archives the one or more data elements associated with the original message in an encrypted format.
